(19) United States
(12) Patent Application Publication
(10) Pub. No.: US 2003/0013779 A1
(43) Pub. Date: Jan. 16, 2003

(54) Flexible polyurethane foam

(75) Inventor: Yoshihiro Katsumata, Kanagawa (JP)

Correspondence Address: KANESAKA AND TAKEUCHI, 1423 Powhatan Street, Alexandria, VA, 22314, US

(73) Assignee: BRIDGESTONE CORPORATION

(21) Appl. No.: 10/227,269

(22) Filed: Aug. 26, 2002

Related U.S. Application Data
(63) Continuation of application No. PCT/JP01/01800, filed on Mar. 8, 2001.

(51) Int. Cl. C08J 9/00

(52) U.S. Cl. 521/155

(57) ABSTRACT

Flexible polyurethane foam having excellent heat and humidity aging characteristics and suitably used as a material for an edge member of a diaphragm of a speaker is obtained by mixing a raw material containing a hydroxyl compound, a polyisocyanate, a foaming agent, a foam stabilizer, and a catalyst and forming the mixture. The flexible polyurethane foam has a molar ratio of urea bond relative to urethane bond of 7 or less.

### CROSS REFERENCE TO RELATED APPLICATION

This is a continuation application of PCT/JP01/01800 filed on Mar. 8, 2001.

### FIELD OF THE INVENTION

The present invention relates to flexible polyurethane foam to be suitably used as a material for an edge member of a diaphragm of a speaker of various sound systems and, more particularly, to flexible polyurethane foam having excellent heat and humidity aging characteristics.

### RELATED ART

An edge member attached to a periphery of a diaphragm of a speaker of a sound instrument or system should have excellent moisture resistance and thermal resistance as well as characteristics of providing excellent tone quality.

A conventional edge member is made from cloth coated or impregnated with a resin, or soft polyurethane foam. Japanese patent publication H8-33095A discloses flexible polyurethane foam which is improved in heat and humidity aging characteristics, and has excellent acoustic properties. To improve the resistance of both moisture and thermal degradation of flexible polyurethane foam, the flexible polyurethane foam is impregnated with a water repellent. There is still need for improving the moisture resistance and the thermal resistance of the flexible polyurethane foam.

### DISCLOSURE OF THE INVENTION

It is an object of the present invention to provide a flexible polyurethane foam having significantly excellent heat and humidity aging characteristics.

It is another object of the present invention to provide flexible polyurethane foam suitably used as a material for an edge of a diaphragm of a speaker.

The flexible polyurethane foam of the present invention is obtained by mixing a raw material containing a hydroxyl compound, a polyisocyanate, a foaming agent, a foam stabilizer, and a catalyst and foaming it, wherein the molar ratio of urea bond relative to urethane bond in the foam is 7 or less.

### DESCRIPTION OF THE PREFERRED EMBODIMENTS

The flexible polyurethane foam has excellent heat and humidity aging characteristics since the molar ratio of the urea bond relative to the urethane bond in the foam is 7 or less, preferably 4 or less, that is, urethane bond/urea bond (molar ratio)=1/7 or less, preferably 1/4 or less.

The molar ratio of urethane bond/urea bond shows a ratio between the number of moles of the urethane bond and the number of moles of urea bond, wherein each number is defined as follows:

Number of moles of urethane bond=(fa×A)/(Mwa×fc²)

Number of moles of urea bond=B/18

wherein

A=parts by weight of hydroxyl compound;

B=parts by weight of water;

fa=number of functional groups of hydroxyl compound;

Mwa=molecular weight of hydroxyl compound; and

fc=number of functional groups of polyisocyanate.

When the raw material consists mainly of the following composition, the molar ratio of the urethane bond/urea bond is calculated to be 1/3.67 as follows:

[Composition (parts by weight)]

Hydroxyl compound A (having the number of functional groups of 3, and a mean molecular weight of 3000): 100

Hydroxyl compound B (having the number of functional groups of 3, and a mean molecular weight of 134): 5

Water: 3.5

Polyisocyanate (having the number of functional groups of 2, and a mean molecular weight of 174): 54.0

(Isocyanate Index: 100)

[Number of moles of urethane bond]

3×100/(300×2²)+3×5/134×2²=0.025+0.028=0.0053

[Number of moles of urea bond]

3.5/18=0.1944

[Urethane bond/Urea bond (molar ratio)]

0.053/0.1944=1/3.67

The flexible polyurethane foam having the aforementioned molar ratio of the urethane bond/urea bond can be manufactured by mixing a low-molecular weight hydroxyl compound, as the hydroxyl compound in the raw material for the foam, in an amount of 0.5-20 parts by weight relative to 100 parts by weight of polyether polyol.

Where the foam stabilizer is a silicon based one modified with polyether and having reactive group(s), the polyurethane foam can be further improved in its heat and humidity aging characteristics.

In the present invention, the content of water as a foaming agent in the raw material for the foam is preferably in a range from 1.0 to 6.0 parts by weight relative to 100 parts by weight of polyether polyol.

The flexible polyurethane foam of the present invention as mentioned above is advantageously used especially as an edge member of a speaker diaphragm.

The flexible polyurethane foam of the present invention has the molar ratio of urethane bond/urea bond of not more than 1/7, preferably not more than 1/4. With urea bond in excess of this range, sufficient heat and humidity aging characteristics can not be obtained. On the other hand, when the number of urea bond are too small, the density of polyurethane foam would be too high. Therefore, the molar ratio is preferably in a range from 1/0.2 to 1/4.0.

The flexible polyurethane foam of the present invention can be made of a raw material containing a low-molecular weight polyol preferably in an amount of 0.5-20 parts by weight, more preferably 3.0-8.0 parts by weight, relative to 100 parts by weight of polyether polyol, as the hydroxyl compound. However, the present invention is not limited to this proportion.

The polyether polyol has preferably a molecular weight of from 3000 to 6000 and contains 50 wt. % or more of secondary hydroxyl group, which is obtained by ring-opening addition bonding of a polyhydroxyl compound such as glycerin, trimethylolpropane, or pentaerythritol, with propylene oxide, ethylene oxide, or the like by using alkaline catalyst. These polyols are normally used for manufacturing flexible polyurethane foams. The most commonly used one among these is poly(oxypropylene)triol, which is obtained by reaction of glycerin with propylene oxide.

Examples of the low-molecular weight polyol include aliphatic alcohols such as ethylene glycol, propylene glycol, diethylene glycol, butanediol, glycerin, trimethylolpropane, triethylolpropane, trimethylolethane, triethylolethane, pentaerythritol, and 1,2,6-hexanetriol.

As a polyisocyanate used in the present invention, tolylene diisocyanate is preferable. Beside tolylene diisocyanate, examples include diphenylmethane diisocyanate, diphenyl diisocyanate, triphenyl diisocyanate, chlorophenyl-2,4-diisocyanate, p-phenylene diisocyanate, xylene diisocyanate, and polyaniline polyisocyanate.

Polyisocyanate is preferably compounded such that an isocyanate index is from 85 to 120.

As a foaming agent, water or a volatile liquid having a low boiling point can be used. Examples of the volatile liquid having a low boiling point include monofluorotrichloromethane, dibromodifluoromethane, dichlorodifluoromethane, dichlorotetrafluoromethane, monochlorodifluoromethane, trifluoroethylbromide, and dichloromethane. These foaming agents may be used alone or in a combination of two or more.

To control the density of the polyurethane foam, the content of water is preferably in a range from 1.0 to 6.0 parts by weight relative to 100 parts by weight of polyether polyol.

The foam stabilizer may be a silicone based one, which is commonly used for flexible polyurethane foam. When the silicone based series stabilizer is modified with a polyether and has an active hydrogen containing group such as a carboxyl group, a hydroxyl group, an amino group, and a methoxy group, preferably a carboxyl group or a hydroxyl group, the polyurethane foam is further improved in its heat and humidity aging characteristics.

The silicone based foam stabilizer is preferably added in an amount of 0.5 to 20.0 parts by weight relative to 100 parts by weight of polyether polyol.

The polyurethane foam may contain any other component which is conventionally contained in a flexible polyurethane foam.

For example, in order to improve the weather resistance, carbon black may be added in an amount of 20.0 parts by weight or less relative to 100 parts by weight of polyether polyol. Besides this, additives such as another pigment, a cross-linking agent, and/or a flame retarder may be added.

The flexible polyurethane foam of the present invention may be manufactured by a so-called one-shot method wherein a polyhydroxyl compound, water, catalyst, and a foam stabilizer are mixed together with the polyisocyanate to react and to foam. Or the flexible polyurethane foam may be manufactured by a two-stage method wherein a part of polyhydroxyl compound is reacted with the entire amount of polyisocyanate to obtain a prepolymer and then the other components are mixed with the prepolymer to be foamed. The catalyst may be mixed with the polyhydroxyl compound in advance and added as a homogeneous solution or dispersion.

The flexible polyurethane foam of the present invention manufactured as mentioned above preferably has a density in a range of 20 to 40 kg/m³ when it is used as a material for an edge member of a diaphragm of a speaker.

Hereinafter, the present invention will be described more concretely with reference to examples and comparative examples.

The following materials are employed in the following examples and comparative examples:

Polyether polyol: “GP3000” available from Sanyo Chemical Industries, Ltd., which is poly(oxypropylene)triol having the number of functional groups of 3 and a molecular weight of 3000;

Trimethylolpropane: This has the number of functional groups of 3, and a molecular weight of 134;

Polyisocyanate: Tolylene diisocyanate having the number of functional groups of 2, and a molecular weight of 174;

Silicone based foam stabilizer: “SRX-280A” available from Dow Corning Toray Silicone Co., Ltd.; and

Reactive silicone based foam stabilizer: “SH193” available from Dow Corning Toray Silicone Co., Ltd., which contains OH groups.

### EXAMPLES 1, 2,

and

### Comparative Example 1

Raw materials shown in Table 1 were mixed and foamed to obtain a flexible polyurethane foam having the molar ratio of urethane bond/urea bond as shown in Table 1. The density, the tensile strength, and the heat and humidity aging characteristics of the flexible polyurethane foam were measured. The results are shown in Table 1.

The tensile strength was measured by tensile tests according to JIS K6400. The heat and humidity aging characteristics was evaluated based on the retention of the tensile strength of the flexible polyurethane foam which was kept in an autoclave at a temperature of 115° C. for 24 hours.

### Comparative Example 2

Flexible polyurethane foam of Comparative Example 2 was manufactured by impregnating the flexible polyurethane foam of Comparative Example 1 with a water-repellent which was an 5% aqueous solution of “TG410” available from Daikin Industries, Ltd. at a rate of 50g/m³. The heat and humidity aging characteristics thereof was measured in the same manner as in Example 1, and the results thereof are shown in Table 1.

TABLE 1

| | Example | | Comparative Example | |
|---|---|---|---|---|
| | 1 | 2 | 1 | 2 |
| Components | | | | |
| (parts by weight) | | | | |
| Polyether polyol | 100 | 100 | 100 | Foam |
| Trimethylolpropane | 5 | 5 | 0 | impregnated |
| Stannous octoate | 0.1 | 0.08 | 0.15 | with |
| Water | 3.5 | 3.5 | 3.5 | water-repellent |
| Triethylenediamine | 0.2 | 0.2 | 0.2 | |
| Silicone based | 1.5 | — | 1.5 | |
| foam stabilizer | | | | |
| Reactive silicone based | — | 1.0 | — | |
| foam stabilizer | | | | |
| Polyisocyanate | 54.0 | 54.0 | 44.0 | |
| Isocyanate index | 100 | 100 | 100 | |
| Urethane bond/urea bond | 1/3.7 | 1/3.7 | 1/7.8 | — |
| (molar ratio) | | | | |
| Density (kg/m³) | 30.5 | 29.3 | 28.5 | — |
| Tensile Strength (kg/cm²) | 0.55 | 0.53 | 0.49 | — |
| | (55) | (53) | (49) | — |
| Heat and humidity aging | 85 | 95 | 40 | 43 |
| characteristics (%) | | | | |

*value in () is in MPa

Table 1 shows that the present invention can provide a flexible polyurethane foam having significantly excellent heat and humidity aging characteristics.

Industrial Applicability

As described above, the flexible polyurethane foam of the present invention has significantly excellent heat and humidity aging characteristics and is suitably used as a material for an edge member of a diaphragm of a speaker.

What is claimed is:

1. A flexible polyurethane foam obtained by mixing a raw material containing a hydroxyl compound, a polyisocyanate, a foaming agent, a foam stabilizer, and catalyst and foaming the mixture,
wherein the flexible polyurethane foam has a molar ratio of urea bond relative to urethane bond of 7 or less.

2. The flexible polyurethane foam as claimed in claim 1, wherein the molar ratio of the urethane bond/urea bond is calculated by dividing the number of moles of the urethane bond by the number of moles of urea bond,
wherein said numbers are defined by the following equations:
the number of moles of urethane bond=(fa×A)/(Mwa×fc²);
and
the number of moles of urea bond=B/18,
wherein
A=amount of the hydroxyl compound in parts by weight;
B=amount of water in parts by weight;
fa=number of functional groups of hydroxyl compound;
Mwa=molecular weight of hydroxyl compound; and
fc=number of functional groups of in a polyisocyanate.

3. The flexible polyurethane foam as claimed in claim 1, wherein the flexible polyurethane foam contains a low-molecular weight hydroxyl compound, as the hydroxyl compound in the raw material for the foam, in an amount of 0.5-20 parts by weight relative to 100 parts by weight of polyether polyol.

4. The flexible polyurethane foam as claimed in claim 1, wherein said foam stabilizer is a silicone based stabilizer modified with a polyether, and has at least one reactive group.

5. The flexible polyurethane foam as claimed in of claim 1, wherein said molar ratio of urea bond relative to urethane bond is 4 or less.

6. The flexible polyurethane foam as claimed in claim 1, wherein said foaming agent is water.

7. The flexible polyurethane foam as claimed in claim 6, wherein the amount of water compounded is 1.0 to 6.0 parts by weight relative to 100 parts by weight of polyether polyol.

8. The flexible polyurethane foam as claimed in claim 1, wherein the flexible polyurethane foam is a material for an edge member of a diaphragm of a speaker.

9. The flexible polyurethane foam as claimed in claim 8, wherein said flexible polyurethane foam has a density of 20 to 40 kg/m³.

10. The flexible polyurethane foam as claimed in claim 2, wherein the polyether polyol has a molecular weight from 3000 to 6000.

11. The flexible polyurethane foam as claimed in claim 1, wherein the hydroxyl compound contains polyether polyol.

12. The flexible polyurethane foam as claimed in claim 11, wherein the flexible polyurethane foam contains a low-molecular weight hydroxyl compound, as the hydroxyl compound in the raw material for the foam, in an amount of 0.5-20 parts by weight relative to 100 parts by weight of polyether polyol.

13. An edge member of a diaphragm of a speaker being made of the flexible polyurethane foam as claimed in claim 1.
